(19) United States
(12) Patent Application Publication
(10) Pub. No.: US 2011/0064202 A1
(43) Pub. Date: Mar. 17, 2011

(54) METHOD AND SYSTEM FOR GENERATING AN X-RAY BEAM

(75) Inventors: Axel Thran, Hamburg (DE); Peter Forthmann, Hamburg (DE); Roland Proksa, Hamburg (DE); Thomas Koehler, Hamburg (DE)

(73) Assignee: KONINKLIJKE PHILIPS ELECTRONICS N.V., EINDHOVEN (NL)

(21) Appl. No.: 12/992,409

(22) PCT Filed: May 8, 2009
(86) PCT No.: PCT/IB09/51906

§ 371 Date: Nov. 12, 2010

(30) Foreign Application Priority Data
May 15, 2008 (CN) 200810099548.0

(51) Int. Cl. H01J 35/08; H01J 35/00; H01J 35/06; H01J 35/30

(52) U.S. Cl. 378/125; 378/121; 378/134; 378/137

(57) ABSTRACT

To scan an object with differently shaped cone beams (112, 122), the present invention provides a CT scanner with a moveable X-ray tube (the meaning of “move the x-ray tube among a plurality of predefined positions” also covers the situation that the anode disk is moved among a plurality of corresponding positions, while the shell of the x-ray tube does not move). The X-ray tube is not only moveable along the axial direction, but also along the radial direction of the CT scanner gantry. The scanner comprises an X-ray tube, which X-ray tube further comprises: an anode disk (100), comprising a plurality of focal tracks (110, 120) each focal track being cone-shaped with an anode angle (114, 124) different from the anode angle(s) of the other focal track(s); and a first cathode (210), configured to emanate an electron beam targeting at least one of the plurality of focal tracks. When different focal tracks are bombarded by electron beams, different X-ray beams (112, 122) with differently shaped cone beams are generated.

### FIELD OF THE INVENTION

The present invention relates to computed tomography methods and apparatus, in particular, to methods and apparatus for performing computed tomography (CT) scans using one X-ray Source.

### BACKGROUND OF THE INVENTION

Conventional multislice X-ray computed tomography (CT) employs an X-ray source to produce a collimated cone-shaped beam directed along the transverse plane through a patient and to be received by a detector array. The X-ray source and the detector array are mounted on a gantry to be rotated about a patient to obtain “projections” measuring X-ray attenuation at the different gantry angles along various X-ray paths through the patient. Projections obtained over a gantry rotation range of at least 180 degrees plus the fan angle subtended by the beam, are used to reconstruct a tomography image.

### SUMMARY OF THE INVENTION

It is an object of the invention to provide an improved X-ray generating apparatus and corresponding methods for scanning.

The basic idea of the present invention is providing a moveable X-ray tube to perform scans having different anode angles. When the moveable X-ray tube is moved to a different position, a scan is performed at a different anode angle. The word “moveable” not only means that the X-ray tube comprises a rotatable anode disk, but also that the X-ray tube can be moved among a plurality of predefined positions, especially along the axial and radial directions of the CT gantry.

By improving the scan geometry, particularly the trajectory of the corresponding focal spots, the so-called cone beam artifacts, are suppressed in the images. By using the apparatus and methods proposed in the present invention, the trajectory of focal spots can be improved by performing different axial scans where the focal spot is located at different Z-positions. Moreover, the advantages of adapting the tilt of the X-ray cone beam to scan the object from different angles can be achieved by utilizing the proposed apparatus having variable anode angles.

In a first aspect, according to an embodiment of the present invention, there is provided a device comprising an anode disk, wherein the anode disk comprises a plurality of focal tracks being cone-shaped with different anode angles.

It is advantageous to generate X-ray beams having different anode angles when different focal tracks are successively bombarded by electron beams.

Optionally, according to an embodiment of the present invention, the device further comprises an X-ray tube, wherein the X-ray tube comprises the anode disk and a first cathode, wherein the first cathode is configured to generate electron beams targeting at least one of the plurality of focal tracks. The device can be a scanner.

Optionally, in another embodiment, the device further comprises a movement controller, which is configured to move the X-ray tube among a plurality of predefined positions.

It is advantageous to adjust the X-ray tube's position, and bombard corresponding focal tracks, based on the position of the X-ray tube, to generate X-ray beams with a corresponding anode angle so as to scan the object from different angles. Another advantage resides in that more projections are generated when the X-ray tube scans the object from different positions. Generating more projections is helpful for mitigating the generation of artifacts in the subsequent image process. Moreover, by arranging the locations of the plurality of predefined positions, the field of view of the scanner, i.e., the Z-range of a scanner, can be extended. It is noted that when the X-ray is moved, the anode disk is also moved. So, the meaning of “move the X-ray tube among a plurality of predefined positions” also covers the situation that the anode disk is moved among a plurality of corresponding positions, while the shell of the X-ray tube does not move.

Optionally, in an embodiment, the movement controller is further configured to move the X-ray tube along its axial and radial directions and to ensure (?) that the movement of corresponding focal spots is parallel to the axis of rotation of the gantry, e.g. the gantry of the scanner. A focal spot is formed when the anode disk is rotating and a corresponding focal track is bombarded by an electron beam. In this embodiment, a plurality of focal spots, formed when the X-ray tube is successively at the plurality of predefined positions, are in a line parallel to the axis of rotation of the gantry.

Optionally, in an embodiment, the device further comprises a focal track selector, which is configured to direct the electron beam to bombard different focal tracks of the plurality of focal tracks, based on different positions of the X-ray tube. For example, the focal track selector, e.g., electron lenses, generates different electronic fields and/or magnetic fields on the electron beam and directs it to bombard different focal tracks. By using the focal track selector, it is advantageous to use only one cathode to generate electron beams to bombard different focal tracks, based on the X-ray tube's different positions. Alternatively, the scanner further comprises a second cathode or more cathodes, wherein different cathodes are each configured to generate electron beams targeted at a different focal track of the plurality of focal tracks.

Optionally, according to an embodiment, the device further comprises a plurality of collimators, wherein each collimator's position corresponds to one corresponding position of the plurality of predefined positions of the X-ray tube. When the X-ray tube is at one of the predefined positions, the corresponding collimator forms the X-ray generated by the X-ray tube. Optionally, at least one collimator has a size different from that of other collimators, which provides the advantage that a different size and/or shape of cone beam can be obtained.

In the second aspect, according to an embodiment of the present invention, there is provided a method of scanning an object, the method comprises the steps of: rotating an anode disk, wherein the anode disk comprises a plurality of focal tracks being cone-shaped with different anode angles; bombarding one of the plurality of focal tracks for generating an X-ray beam, wherein the anode angle of the generated X-ray beam is determined by the anode angle of the bombarded focal track.

Optionally, according to an embodiment, the method further comprises the steps of: moving the anode disk to a first predefined position; performing a first scan with a first focal track of the plurality of focal tracks being bombarded by a first electron beam; moving the anode disk to a second predefined position; and performing a second scan with a second focal track of the plurality of focal tracks being bombarded by a second electron beam.

By using the provided method, it is advantageous to perform two or more scans having different z-positions of the x-ray source, which further provides advantages for suppressing artifacts in the subsequent image processing. Optionally, an X-ray tube comprising the anode disk can be moved as a whole. In such an embodiment, a cathode comprised in the X-ray tube is also moved in the same way.

These and other aspects, features and/or advantages of the invention will be apparent from and elucidated with reference to the embodiments described hereinafter.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1a depicts a front view of an anode disk comprising a plurality of focal tracks, according to an embodiment of the present invention;

FIG. 1b depicts a side view of the anode disk of FIG. 1a;

FIG. 1c depicts a side view of an anode disk, according to an embodiment of the present invention;

FIG. 2a depicts an X-ray tube comprising one cathode, according to an embodiment of the present invention;

FIG. 2b depicts an X-ray tube comprising two cathodes, according to an embodiment of the present invention;

FIG. 3 depicts the block diagram of a scanner according to an embodiment of the present invention;

FIG. 4 depicts the working principle of a scanner, according to an embodiment of the present invention;

FIG. 5 depicts the movement of X-ray tube, according to an embodiment of the present invention;

FIG. 6 depicts the generation of different cone beams having different cone angles, according to an embodiment of the present invention;

FIG. 7 illustrates an embodiment to realize different Z-ranges;

FIG. 8 depicts a working flowchart of a method used in a scanner according to an embodiment of the present invention.

### DETAILED DESCRIPTION OF THE EMBODIMENTS

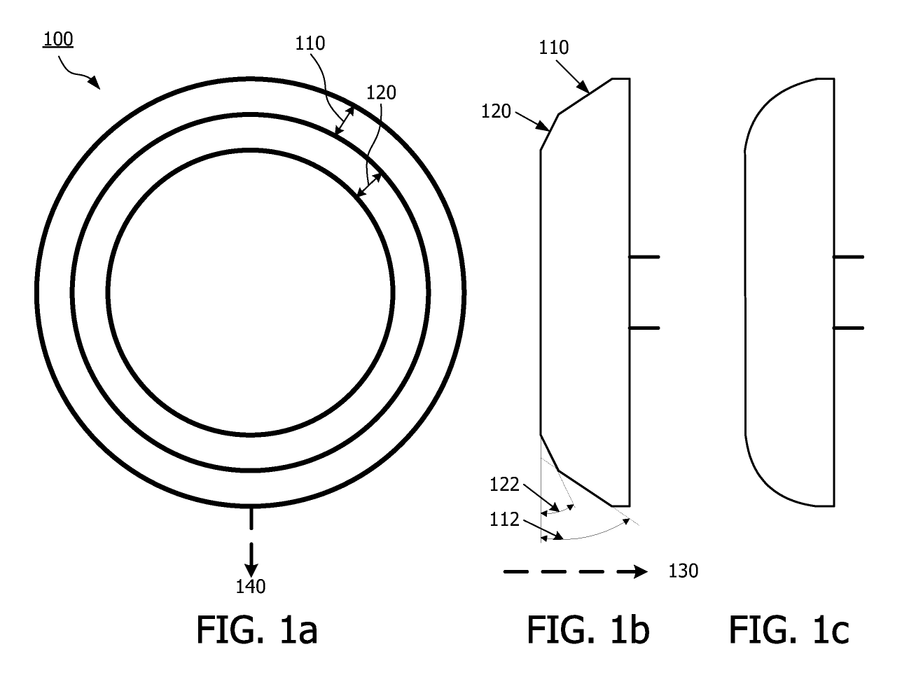

FIG. 1a illustrates an anode disk according to an embodiment of the present invention. The anode disk 100 comprises a plurality of focal tracks, e.g., a first focal track 110 and a second focal track 120. Each focal track is cone-shaped, the axis of the cones corresponding to the center of the 3 circular lines, and different focal tracks have different anode angles. The anode angle of a focal track affects the X-ray beam, which is generated when the focal track 110 or 120 is bombarded by an electron beam. In other words, when different focal tracks are bombarded by electron beams, the anode disk 100 generates X-ray beams having different cone angle ranges. The anode disk can be an element of an X-ray scanner, for example a CT scanner.

FIG. 1b illustrates a side view of the anode disk, in particular the different anode angles of different focal tracks. The anode angle is the angle between a vertical line in FIG. 1b and the anode surface in the region of the focal track, for example, the focal track 110 has the anode angle 112, and the focal track 120 has the anode angle 122. The anode disk 100 may comprise more than two focal tracks for generating X-ray beams having different anode angles, each focal track having an anode angle different from the anode angle of other focal tracks. Optionally, as shown in FIG. 1c, the plurality of focal tracks can form a convex area, which allows a continuously selectable anode angle. In FIGS. 1a-1c, the arrows 130 and 140 respectively represent the axial direction and the radial direction of the anode disk when the anode disk is moved from a first position to a second position.

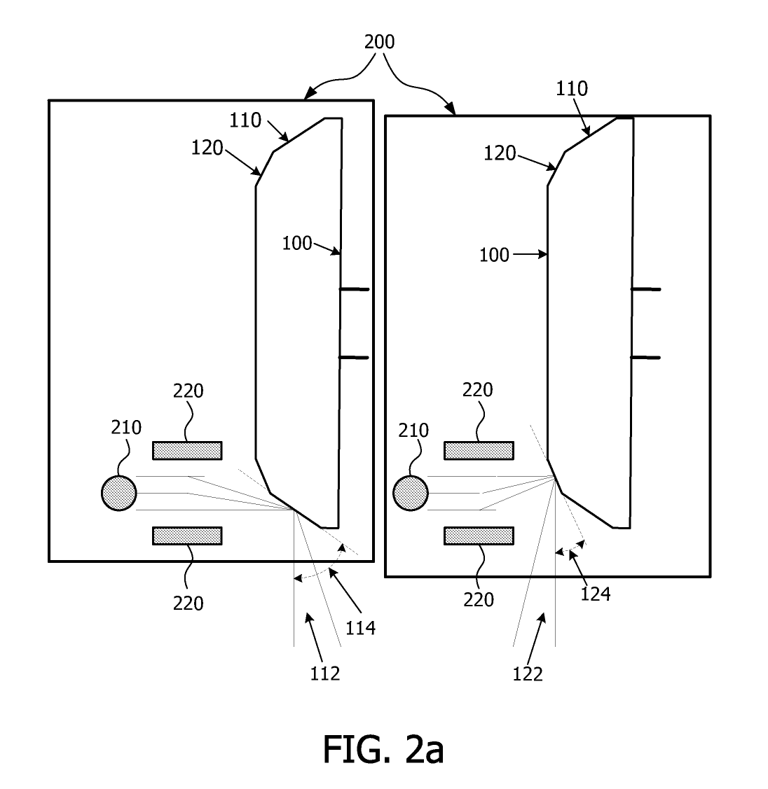

FIG. 2a illustrates an X-ray tube 200 comprising an anode disk 100 (in a first position on the left side, in a second position on the right side) and a first cathode 210. The first cathode 210 is configured to generate an electron beam targeting at least one focal track of the anode disk 100. When the anode disk is rotating and one focal track is bombarded by the electron beam generated from the first cathode 210, an X-ray beam is generated with a corresponding anode angle.

For example, when the first focal track 110 having anode angle 114 is bombarded, X-ray beam 112 is generated; and when the second focal track 120 with anode angle 124 is bombarded, X-ray beam 122 is generated.

For selecting the focal track which is to be bombarded, in an embodiment of the present invention, a focal track selector 220 is provided. The focal track selector 220 is configured to direct the electron beam generated by the first cathode 210 so as to bombard one focal track, e.g. the first focal track 110 or the second focal track 120. The focal track selector 220 generates an electronic field and/or magnetic field on the electron beam to direct it to the desired focal track.

In the exemplary embodiment of FIG. 2a, the focal track selector 220 is a pair of electron lenses. The skilled person should understand that other means capable of directing an electron beam to a selected focal track are also applicable for this invention.
By using the focal track selector 220, it is advantageous to use only one cathode to bombard a succession of different focal tracks.

Alternatively, in the exemplary embodiment shown in FIG. 2b, the X-ray tube 200′ further comprises a second cathode 230 to generate an electron beam for bombarding one of the plurality of focal tracks 110-120. The first cathode 210 and the second cathode 230 are arranged to bombard different focal tracks. In this embodiment, there is no need for a focal track selector. It is feasible for the X-ray tube 200 to comprise more than two cathodes.

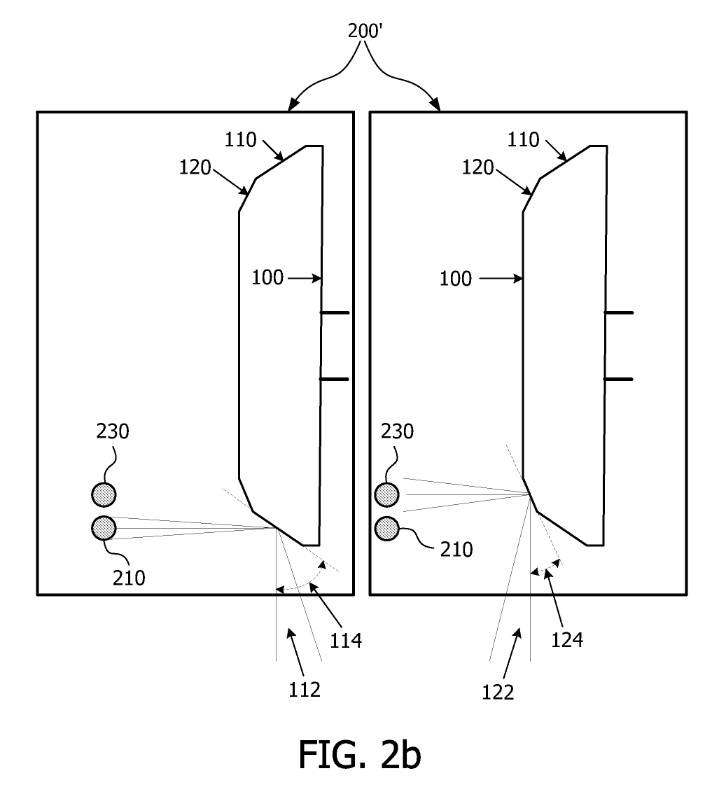

FIG. 3 illustrates a block diagram of a scanner 300, according to an embodiment of the present invention.

The scanner 300 comprises an X-ray tube 200 and a movement controller 310. The movement controller 310 is configured to move the X-ray tube 200 among a plurality of predefined positions. For example, the plurality of predefined positions can be arranged along the Z-axis of the CT scanner. Once moved to a predefined position, the X-ray tube 200 performs a scan, in which a corresponding focal track is selected and bombarded by an electron beam, for generating a corresponding X-ray beam with a corresponding anode angle. When the X-ray tube is placed at different positions, different focal tracks are selected and different X-ray beams having different anode angles are generated.

Optionally, the scanner 300 further comprises a plurality of collimators 320. Each collimator is located with respect to a predefined position of the X-ray tube 200, and is configured to collimate a corresponding X-ray beam when the X-ray tube 200 is placed at the predefined position. The cone angle of an X-ray cone beam traversing a scanned object is determined by the anode angle of the bombarded focal track and the position and/or size of the collimator.

Optionally, to generate different X-ray cone beams having different cone angles, in an embodiment of the present invention, at least one of the collimator sizes is different from that of other collimators. Furthermore, in another embodiment, the collimators' positions can be arranged such that some collimators can shape the X-ray beams so as to be symmetric cone beams, while other collimators shape the X-ray beams so as to be asymmetric cone beams.

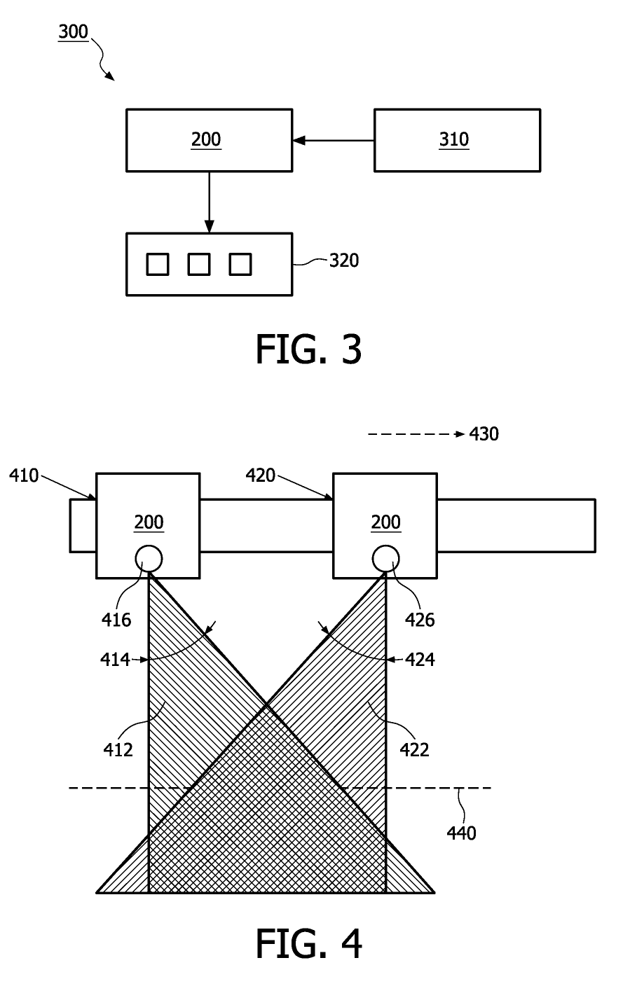

FIG. 4 illustrates the working principle of a scanner according to an embodiment of the present invention.

Reference sign 430 represents the axis direction of the gantry of the scanner, and reference sign 440 represents the axis of rotation of the gantry of the scanner, also referred to as z-axis.

The provided scanner 300 first places the X-ray tube 200 at the first predefined position 410, and performs a first scan. A first focal spot 416 is formed when one focal track of the anode disk 100, for example, the first focal track 110, is bombarded. In the first scan, the X-ray tube 200 generates a cone beam 412 with a cone angle 414 to scan an object, which is not shown in this Figure.

After the first scan is performed, the scanner 300 moves the X-ray tube 200 to the second predefined position 420, and performs a second scan. In the second scan, the second focal track 120 is bombarded, and a second focal spot 426 is formed. Cone beam 422 having a cone angle 424 is generated.

In this embodiment, a scan is performed when the X-ray tube 200 is at one of the plurality of predefined positions.

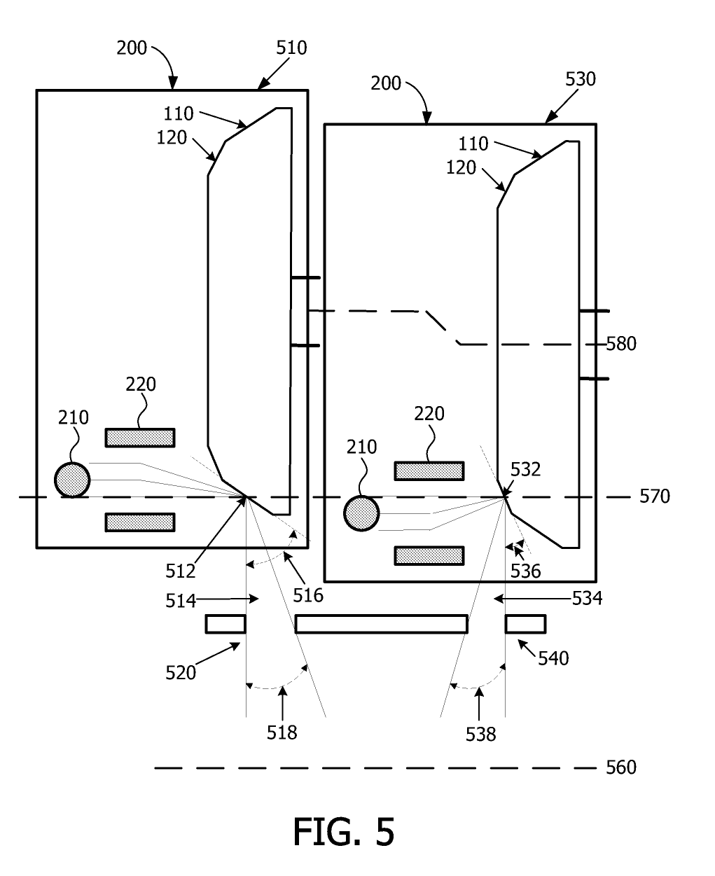

FIG. 5 illustrates an exemplary embodiment of the movement of the X-ray tube.

First, the X-ray tube 200 is placed at a first position 510, and the first cathode 210 generates an electron beam. The focal track selector 220 exerts a force on, and directs, the electron beam to bombard the first focal track 110. When the first focal track 110 having the anode angle 516 is bombarded while the anode disk 100 is rotating, a first focal spot 512 is formed, and a first X-ray beam 514 is formed. The generated X-ray beam 514 is collimated by a corresponding first collimator 520 to a first cone angle 518, and targets the scanned object.

After a first scan is performed with the first X-ray beam 514, the X-ray tube 200 is moved to a second position 530. At the second position 530, the focal track selector 220 exerts a different force on the electron beam generated by the first cathode 210, and directs the electron beam to bombard the second focal track 120 having the anode angle 536. While the anode disk 100 is rotating, a second focal spot 532 is formed and a second X-ray beam 534 is formed. The second X-ray beam 534 is collimated by a corresponding second collimator 540 to a second cone angle 538. A second scan is thus performed by using the second X-ray beam.

In the embodiment of FIG. 5, a plurality of collimators are shown, each collimator corresponding to a predefined position of the X-ray tube. The function of each collimator is to collimate the X-ray beam when the X-ray tube is at the corresponding position.

As the first focal spot 512 and the second focal spot 532 are formed on different focal tracks, the distance between the first focal spot 512 and the axis of rotation 560 of the gantry of the scanner may be different from the distance between the second focal spot 532 and the axis 560. The difference is compensated by moving the X-ray tube in a radial direction between both positions. The X-ray tube is moved such that the distance between the first focal spot 512 and axis 560 is the same as the distance between the second focal spot 532 and the axis 560. In other words, the dotted line 570 defined by the two focal spots 512/532 remains parallel to the axis of rotation 560. In this embodiment, the movement of the X-ray tube 580 does not stay parallel to axis 560, which means the X-ray tube is moved, by the movement controller, not only along its axial direction, but also along its radial direction.

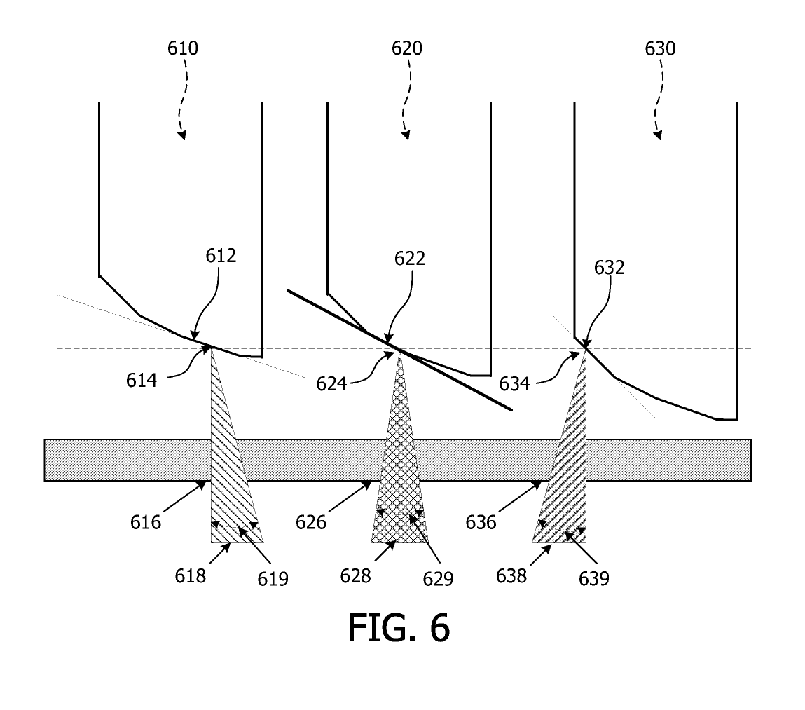

FIG. 6 depicts the generation of different cone beams having different cone angles, according to an embodiment of the present invention.

When the X-ray tube is placed at position 610, a first focal track 612 is bombarded and a first focal spot 614 is formed. After being collimated by a corresponding collimator 616, a cone beam 618 having a cone angle 619 is formed.

When the X-ray tube is placed at position 620, a second focal track 622 is bombarded and a second focal spot 624 is formed. A symmetric cone beam 628 having a cone angle 629 is formed, due to the position and size of the second collimator 626.

When the X-ray tube is at position 630, a third focal track 632 is bombarded and a third focal spot 634 is formed.

It is noted that the three focal spots 614, 624 and 634 are along a dotted line parallel to the axis of rotation of the gantry of the scanner, which means that the distance between each focal spot and the axis of rotation of the gantry is the same. The X-ray tube itself is moved along its axial direction and radial direction. It is noted that the size of collimators could be different. At least one collimator may have a different size compared to the size of other collimators.

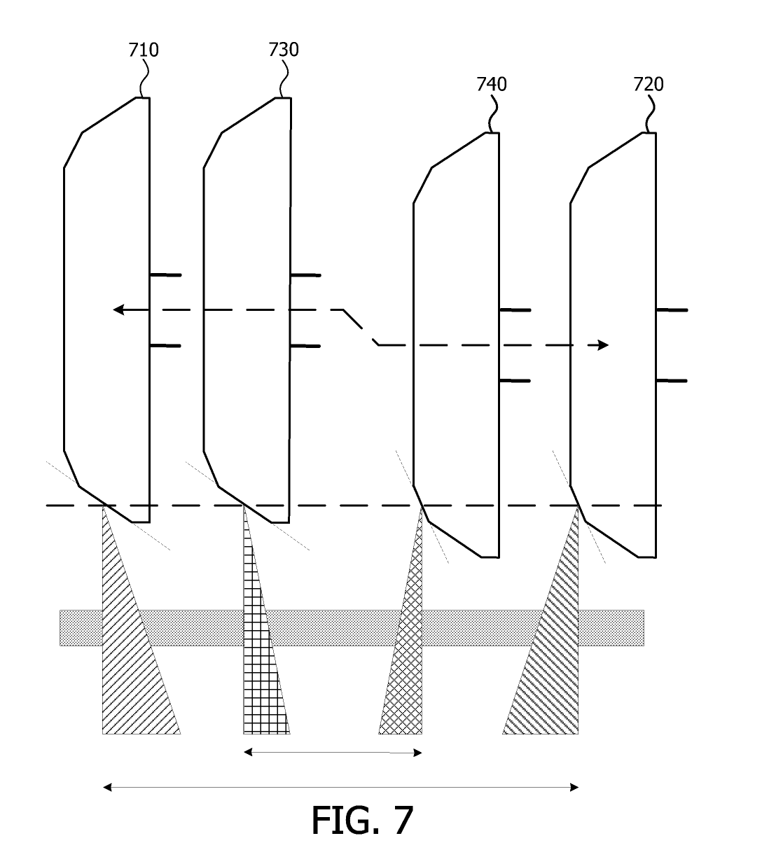

FIG. 7 illustrates an embodiment for realizing different Z-ranges. Scanning with the X-ray tube in positions 710 and 720 yields a Z-range larger than scanning with the X-ray tube in positions 730 and 740. By having different distances among the plurality of predefined positions, different Z-ranges can be realized.

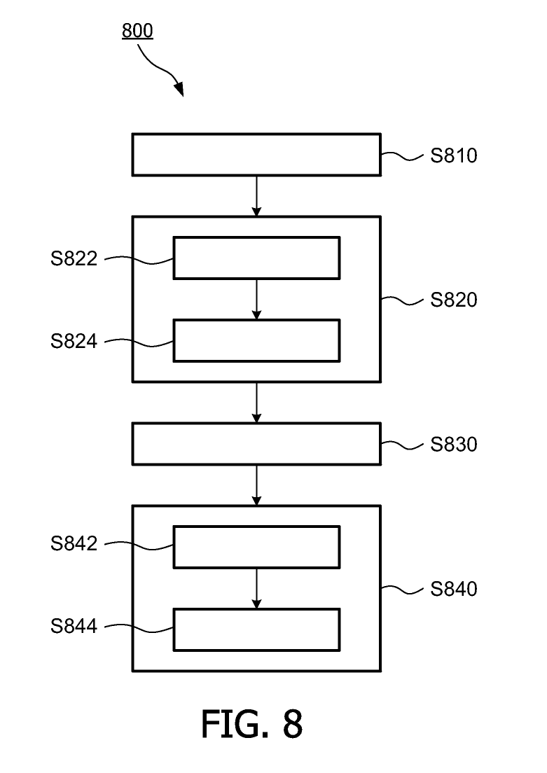

FIG. 8 depicts a working flowchart of a method used in a scanner according to an embodiment of the present invention.

The method 800 first comprises a step S810 to move the X-ray tube to a first predefined position.

Then the method further comprises a step S820 of performing a first scan of a given object of interest. During the first scan, a first focal track of the X-ray tube is bombarded, and a first X-ray beam having a first anode angle is formed.

The method further comprises a step S830 to move the X-ray tube to a second predefined position. The X-ray tube is moved along its axial and radial directions, to make sure that a first focal spot formed in the first scan and a second focal spot formed in the second scan are in a line parallel to the axis of rotation of the gantry of the scanner. In another word, the X-ray tube is moved in such a way as to keep the distance between the first focal spot and the axis of rotation of the gantry the same as the distance between the second focal spot and the axis of rotation of the gantry.

In step S840, a second scan is performed, and a second focal track is bombarded. During the second scan, a second X-ray beam is formed with a second anode angle. Generally, the first anode angle and the second anode angle are different.

Optionally, in one embodiment, the step S820 further comprises a step S822 of generating a first electron beam by a cathode, and a step S824 of directing the first electron beam to bombard the first focal track by exerting a first force on the first electron beam.

The step S840 further comprises a step S842 of generating the second electron beam by the cathode, and a step S844 of directing the second electron beam to bombard the second focal track by exerting a second force on the second electron beam.

Alternatively, in another embodiment, the step S820 further comprises a step of generating the first electron beam by a first cathode, and the step S840 further comprises a step of generating the second electron beam by a second cathode.

It should be noted that the above-mentioned embodiments illustrate rather than limit the invention and that those skilled in the art will be able to design many alternative embodiments without departing from the spirit or scope of the invention. Therefore, the scope of the invention shall be limited only by the appended claims.

The remarks made hereinbefore demonstrate that the detailed description with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A device for generating an X-ray beam, the device comprising an anode disk, wherein the anode disk comprises a plurality of focal tracks being cone-shaped with different anode angles.

2. The device as claimed in claim 1, further comprising an X-ray tube, wherein the X-ray tube comprises: the anode disk; and
a first cathode configured to generate electron beams targeting at least one of the plurality of focal tracks.

3. The device as claimed in claim 2, further comprising a movement controller, configured to move the x-ray tube among a plurality of predefined positions.

4. The device as claimed in claim 2, wherein the X-ray tube further comprises: a second cathode, configured to generate an electron beam targeting at least one of the plurality of focal tracks, said at least one of the focal tracks being different from the focal track targeted by the first cathode.

5. The device as claimed in claim 2, wherein the X-ray tube further comprises a focal track selector, configured to direct the electron beam generated by the first cathode to bombard different focal tracks, according to different positions of the X-ray tube.

6. The device as claimed in claim 5, wherein the focal track selector is further configured to generate an electronic field and/or magnetic field to direct the electron beam generated by the first cathode.

7. The device as claimed in claim 3, wherein the movement controller is further configured to move the X-ray tube along the axial direction and radial direction of a gantry so as to ensure that the distance between a focal spot and the gantry is the same in spite of the X-ray tube's positions, wherein the focal spot is formed when the X-ray tube is at one of the plurality of pre-defined positions and a corresponding focal track is bombarded.

8. The device as claimed in claim 3, further comprising a plurality of collimators, wherein the position of each collimator corresponds to one position among a plurality of predefined positions of the X-ray tube, and each collimator is configured to collimate X-ray beams generated by the X-ray tube.

9. The device as claimed in claim 8, wherein at least the size of one collimator is different from the size(s) of the others collimators of the plurality of collimators.

10. The device as claimed in claim 1, wherein the plurality of focal tracks form a convex surface.

11. A method of scanning an object, comprising the steps of:
rotating an anode disk, wherein the anode disk comprises a plurality of focal tracks being cone-shaped with different anode angles; and
bombarding one of the plurality of focal tracks for generating an X-ray beam, wherein the anode angle of the generated X-ray beam is determined by the anode angle of the bombarded focal track.

12. The method as claimed in claim 11, further comprising the steps of:
moving the anode disk to a first predefined position;
performing a first scan with a first focal track of the plurality of focal tracks being bombarded by a first electron beam;
moving the anode disk to a second predefined position; and
performing a second scan with a second focal track of the plurality of focal tracks being bombarded by a second electron beam.

13. The method as claimed in claim 12, wherein the steps of moving the anode disk further comprise moving the anode disk along the axial direction and radial direction of the anode disk to reach the first predefined position and the second predefined position, respectively.

14. The method as claimed in claim 12, wherein the distance between a first focal spot and the axis of rotation of a gantry and the distance between a second focal spot and the axis of rotation of the gantry are the same, wherein the first focal spot and the second focal spot are formed when the first focal track and the second focal track are bombarded, respectively.

15. The method as claimed in claim 12, wherein the step of performing the first scan further comprises the steps of:
generating the first electron beam by a cathode;
directing the first electron beam to bombard the first focal track by exerting a first force on the first electron beam, and the step of performing the second scan further comprises the steps of:
generating the second electron beam by the cathode; directing the second electron beam to bombard the second focal track by exerting a second force on the second electron beam.
